(19) United States
(12) Patent Application Publication
(10) Pub. No.: US 2007/0042092 A1
(43) Pub. Date: Feb. 22, 2007

(54) Process for reducing acrylamide in cooked food

(76) Inventors: Stephen D. Kelleher, Ipswich, MA (US); Karen E. Basian, Toronto (CA)

Correspondence Address: Paul J. Cook, 115 Pine Street, Manchester, MA, 01944, US

(21) Appl. No.: 11/543,616

(22) Filed: Oct. 6, 2006

Related U.S. Application Data
(63) Continuation-in-part of application No. 10/991,637, filed on Nov. 18, 2004.
Application No. 10/991,637 is a continuation-in-part of application No. 10/378,139, filed on Mar. 4, 2003, now Pat. No. 6,855,364.
Application No. 10/378,139 is a continuation-in-part of application No. 10/252,873, filed on Sep. 24, 2002, now abandoned.
(60) Provisional application No. 60/731,821, filed on Nov. 1, 2005.

(51) Int. Cl. A23L 1/31

(52) U.S. Cl. 426/281

(57) ABSTRACT

A process for cooking a food while minimizing acrylamide formation in the food is provided. A dry protein mixture, a dry alkaline protein mixture, an aqueous alkaline protein mixture or an aqueous acidic protein is added to a food prior to cooking. The dry protein mixture, dry alkaline protein mixture, aqueous alkaline protein mixture and aqueous acidic protein solution comprise myofibrillar proteins and sarcoplasmic proteins substantially free of myofibrils and sarcomeres.

### REFERENCE TO RELATED APPLICATIONS

This application is based on provisional application Ser. No. 60/731,821, filed Nov. 1, 2005 which is a continuation-in part of application Ser. No. 10/991,637 filed Nov. 18, 2004 which, in turn is a continuation-in part of application Ser. No. 10/378,139, filed Mar. 4, 2003, which, in turn, is a continuation-in part of application Ser. No. 10/252,873, filed Sep. 24, 2002.

### BACKGROUND OF THE INVENTION

This invention relates to a process for reducing acrylamide formation in cooked food. More particularly, this invention relates to a process for reducing acrylamide formation in cooked food containing asparagine.

It is known that acrylamide is formed in cooked food when heated to a temperature that supports the reaction of asparagine and reducing sugars (aldose) present in the food. The reaction involved is known as a Maillard reaction and involves the condensation of asparagine and reducing sugars in the food to form acrylamide. Generally, the reaction is effected at about 140° and above.

It has been reported in the literature (Center for Science in the Public Interest, Jun. 25, 2002), that acrylamide may cause cancer in animals. Representative foods containing asparagine and reducing sugars include potatoes, such as french fried potatoes, potato chips, corn based chips, taco shells and breakfast cereals.

It has been proposed by both Kim et al, “Reduction of acrylamide in fried foods by addition of amino acids and vacuum frying”, Seoul National University and Rydberg et al, Journal of Agricultural and Food Chemistry, 2003, 51, 7012-7018 that adding amino acids to a food to be cooked to reduce acrylamide formation in the food. Unfortunately, solutions of amino acids do not form a stable coating on the food. Thus, the solutions can be easily removed from the food.

It would be desirable to provide a process for reducing acrylamide formation in cooked foods. It also would be desirable to provide such a process wherein the means for effecting reduction in acrylamide formation remains with the food in order to provide a continuing effect in the reduction.

### SUMMARY OF THE INVENTION

In accordance with this invention, uncooked food containing asparagines and reducing sugars to be cooked is coated, injected and/or admixed with a dry protein mixture or an aqueous acidic solution of protein mixture derived from animal muscle tissue and/or with a peptide composition derived from the mixture or from the aqueous acidic solution of protein mixture in order to reduce acrylamide formation in the food during cooking at a temperature above about 140° C. The protein mixtures comprise a mixture of myofibrillar proteins and sarcoplasmic proteins obtained by one of the processes disclosed in U.S. Pat. Nos. 6,005,073; 6,288,216; 6,136,959 and/or 6,451,975 all of which are incorporated herein by reference in their entirety. By the phrase, “dry protein mixture” as used herein is meant a dehydrated, protein mixture of myofibrillar proteins and sarcoplasmic proteins derived from animal muscle tissue and which is obtained from an aqueous acid solution (less than or equal to pH 4.0) or an aqueous alkaline solution (greater than or equal to pH 10.5). The dry protein mixture also contains less than about 15 weight percent water, preferably between about 3 and 10 weight percent water and most preferably between about 3 and 7 weight percent water based on the total weight of the protein mixture and water. While a dry protein mixture containing 0% water is useful in the present invention, dry powders, in general, containing 0 to 3 weight percent water can be dangerous to process on a commercial scale. Solid mixtures of myofibrillar proteins and sarcoplasmic proteins containing greater than about 15 weight percent water based on total weight of the protein mixture and water are undesirable in this invention since they are microbially unsound.

By the phrase “aqueous acidic protein solution” as used herein is meant an aqueous solution of myofibrillar proteins and sarcoplasmic proteins derived from animal muscle tissue and having a pH of 4.0 or less, preferably pH 3.5 or less and most preferably between about 2.5 and about 3.5, but not so low as to adversely affect the protein functionality. The aqueous acidic protein solution can be obtained directly from animal muscle tissue by the processes described below or by dissolving the dry protein mixture in water or in a pharmaceutically or food grade acceptable aqueous acidic solution.

By the phrase, “aqueous alkaline protein solution” as used herein is meant an aqueous solution of myofibrillar proteins and sarcoplasmic proteins having a pH from about 10.5 to about 12.0. The aqueous alkaline protein solution can be obtained directly from animal muscle tissue by the process described below. A dry alkaline protein mixture is obtained by drying the aqueous alkaline protein solution such as by lyophilization, evaporation or spray drying.

In accordance with this invention the dry protein mixture or dry alkaline protein mixture of myofibrillar proteins and sarcoplasmic protein, in powder form, dehydrated form or small particulate form or peptide composition derived from the dry protein mixture is applied to the surface of the food to be cooked, is injected into the food to be cooked and/or is mixed with the food (ground, minced or thinly sliced) to be cooked such as hamburger or sausage. Alternatively, the aqueous acidic protein solution or aqueous alkaline protein solution or peptide composition derived from the aqueous acidic protein solution or aqueous alkaline protein solution can be applied to the surface of the food or it can be mixed with the food or it can be injected into the food. The food containing the dry protein mixture, dry alkaline protein mixture, aqueous alkaline protein solution or aqueous acidic protein solution or peptide composition derived therefrom then can be cooked such as by baking or frying such as by deep fat frying at a temperature above about 140° C. up to a temperature where the food is overcooked reducing acrylamide formation in the food. The difference in weight of acrylamide treated in accordance with this invention after being cooked in compared with food without the dry protein mixture or aqueous acidic protein solution or peptide composition derived therefrom after being cooked in is between about 25 and about 95%, preferably, between about 50 and about 95% less acrylamide.

Alternatively, in accordance with this invention the dry alkaline protein mixture of myofibrillar proteins and sarcoplasmic protein, in powder form, dehydrated form or small particulate form or peptide composition derived from the dry alkaline protein mixture is applied to the surface of the food to be cooked, is injected into the food to be cooked, is injected into the food to be cooked and/or is mixed with the food (ground, minced or thinly sliced) to be cooked such as hamburger or sausage. Alternatively, the aqueous alkaline protein solution or peptide composition derived from the aqueous alkaline protein solution can be applied to the surface of the food or it can be mixed with the food or it can be injected into the food. The food containing the dry protein mixture or aqueous alkaline protein solution or peptide composition derived therefrom then can be cooked at elevated temperature above about 140° C. while minimizing formation of acrylamide. The difference in acrylamide formation between food treated in accordance with this invention after being cooked compared with food without the dry alkaline protein mixture or aqueous alkaline protein solution or peptide composition derived therefrom after being cooked is between about 25 and about 95%, preferably, between about 50 and about 95% less acrylamide.

The peptide composition useful in the present invention is obtained by contacting the dry protein mixture, the aqueous acidic protein solution; the aqueous alkaline protein solution or the dry alkaline protein mixture with an enzyme composition which converts the protein to a peptide composition at the pH of the protein. The peptide composition can be a dry peptide composition, an aqueous acidic peptide composition, an aqueous alkaline peptide solution or a dry alkaline peptide mixture.

### DESCRIPTION OF SPECIFIC EMBODIMENTS

In accordance with this invention, food containing asparagine and reducing sugars to be cooked at above about 140° C. is coated, injected with and/or admixed with a dry protein mixture, a dry alkaline protein mixture, an aqueous acidic protein solution or an aqueous alkaline protein solution of myofibrillar proteins and sarcoplasmic proteins derived from animal muscle tissue and/or a peptide composition derived from the dry protein mixture, the dry alkaline protein mixture, the aqueous acidic protein solution or the aqueous alkaline protein solution. The dry protein mixture, dry protein alkaline mixture, aqueous alkaline protein solution and aqueous acidic protein solution are obtained by the processes disclosed in U.S. Pat. Nos. 6,005,073, 6,288,216, 6,136,959 and 6,451,975 all of which are incorporated herein by reference in their entirety. The peptide composition utilized in the present invention is obtained by contacting the dry protein mixture, the aqueous acidic protein solution, the dry alkaline protein mixture or an aqueous alkaline protein solution with an enzyme that converts the protein to a peptide. This dry protein mixture is obtained by one of four processes. In two processes, (acid processes) animal muscle tissue is formed into small tissue particles which are then mixed with sufficient acid to form a solution of the tissue having a pH of 4.0 or less, preferably 3.5 or less and most preferably between about 2.5 and about 3.5, but not such a low pH as to adversely modify the animal tissue protein. In one of these two processes, the solution is centrifuged to form a lowest membrane lipid layer, an intermediate layer of aqueous acidic protein solution and a top layer of neutral lipids (fats and oils). The intermediate layer of aqueous acidic protein solution then is separated from the membrane lipid layer or from both the membrane lipid layer and the neutral lipid layer. In a second of these two processes, no centrifugation step is effected since the starting animal muscle tissue contains low concentrations of undesired membrane lipids, oils and/or fats. In both processes, the protein mixture is free of myofibrils and sarcomeres. In both processes, the protein in the aqueous acidic protein solution is recovered after centrifugation (when used) or by drying the aqueous acidic solution, such as by evaporation, spray drying or lyophilization to form the dry protein mixture having the low pH it had when it was dissolved in the aqueous acidic protein solution. Alternatively, the aqueous acidic protein solution can be utilized with the uncooked food without drying the solution. It is preferred to utilize one of these two acid processes to obtain the dry protein mixture or the aqueous acidic protein solution. In another alternative process, the protein in the aqueous acidic protein solution can be precipitated and recovered and mixed with a pharmaceutically acceptable or food grade acid to form an aqueous acidic protein solution of a desired viscosity. In another alternative process, the proteins in the acidic protein solution can be raised to a pH between about 10.5 and 12 using base to form an aqueous alkaline protein solution.

In two other processes, (alkaline processes) which also provide a means for obtaining the dry alkaline protein mixture, animal muscle tissue is formed into small tissue particles which are then mixed with sufficient aqueous base solution to form a solution of the tissue wherein at least 75% of the animal muscle protein is solubilized, but not such a high pH as to adversely modify the animal tissue protein, i.e., a pH between about 10.5 and about 12. In one process, the solution is centrifuged to form a lowest membrane lipid layer, an intermediate aqueous protein rich layer and a top layer of neutral lipids (fats and oils). The intermediate aqueous alkaline protein-rich layer then is separated from the membrane lipid layer or from both the membrane lipid layer and the neutral lipid layer. In a second process, no centrifugation step is effected since the starting animal muscle proteins contain low concentrations of undesired membrane lipids, oils and/or fats. In both processes, the protein mixture is free of myofibrils and sarcomeres. In both of these processes, the aqueous alkaline protein solution can be recovered at this point. In both processes, the pH of the protein-rich aqueous phase can be lowered to a pH below about 4.0, preferably below about 3.5 and most preferably between about 2.0 and 3.5 to form the aqueous acidic protein solution. In both processes, the protein in the aqueous acidic protein solution is recovered after centrifugation (when used) by drying the aqueous acidic protein solution, such as by evaporation, spray drying or lyophilization to form a powder product having the low pH it had when it was dissolved in the aqueous acidic solution. Alternatively, the aqueous acidic protein solution can be applied directly to the food without drying. The protein in aqueous alkaline solution having a pH between about 10.5 and 12.0 recovered after centrifugation (when used) can be dried, such as by spray drying, evaporation or lyophilization to form a powder product.

The dry protein mixture, the dry alkaline protein mixture, the aqueous acidic protein solution or the aqueous alkaline protein solution then is coated or injected into and/or admixed with the uncooked food. The dry protein mixture, dry alkaline protein mixture, aqueous acidic protein solution, or aqueous acidic protein solution and/or peptide composition derived therefrom can be applied alone or in admixture with conventional food or nutritive additives such as breading or batter coatings, spice dry rubs, cracker meal, corn meal or the like. The dry protein mixture, the dry alkaline protein mixture, the aqueous alkaline protein solution or aqueous acidic protein solution and/or peptide composition derived therefrom can be coated on the surface of the uncooked food with an applicator or can be coated by immersion tumbling the uncooked food in the solution or in a marinade containing the acidic aqueous protein solution, the dry alkaline protein mixture, or the aqueous alkaline protein solution or dry acidic protein mixture in a container or tumbling or vacuum tumbling apparatus. The dry protein mixture, dry alkaline protein mixture, aqueous acidic protein solution or aqueous alkaline protein solution also can contain flavorants such as butter flavor or garlic flavor or the like.

In summary, the dry protein mixture, dry alkaline protein mixture, aqueous alkaline protein mixture or the aqueous acidic protein solution utilized in the present invention can be obtained by the following representative methods:

1. Reduce the pH of comminuted animal muscle tissue to a pH less than about 3.5 to form an acidic protein solution, centrifuge the solution to form a lipid-rich phase and an aqueous phase and recover an aqueous acidic protein solution substantially free of membrane lipids that can be used in this invention.

2. Spray dry the aqueous acidic protein solution obtained by method 1 to form a dry protein mixture substantially free of membrane lipids that can be used in the present invention.

3. Lyophilize or evaporate the aqueous acidic protein solution obtained by method 1 to form the dry protein mixture substantially free of membrane lipids that can be used in the present invention.

4. Increase the pH of the aqueous acidic protein solution from method 1 to about pH 5.0-5.5 to effect precipitation of the proteins and then readjust the protein back to a pH of about 4.5 or less using acid in a minimum volume to concentrate the aqueous acidic protein solution to between 1.6-15% protein.

5. Reduce the pH of comminuted animal muscle tissue to form an aqueous acidic protein solution that can be used in the present invention.

6. Spray dry the aqueous acidic protein solution obtained by method 5 to form the dry protein mixture that can be used in the present invention.

7. Lyophilize or evaporate the aqueous acidic protein solution obtained by method 5 to form the dry protein mixture that can be used in the present invention.

8. Increase the pH of the aqueous acidic protein solution from method 5 to about pH 5.0-5.5 to effect precipitation of the proteins and then readjust the protein back to a pH of about 4.0 or less using acid in a minimum volume to concentrate the aqueous acidic protein solution to between about 1.6-15% protein.

9. Increase the pH of comminuted animal muscle tissue to a pH above about 10.5, centrifuge the solution to form a lipid-rich phase and an aqueous phase and recover an aqueous alkaline protein solution. In one embodiment, reduce the pH of the aqueous alkaline solution to a pH of less than about 4.0 to obtain an aqueous acidic protein solution substantially free of membrane lipids that can be used in this invention. In a second embodiment, reduce the pH of the aqueous alkaline solution to about 5.0-5.5 to precipitate the protein, lower the pH of the precipitated protein to a pH of 4.0 or less to form a concentrated aqueous acidic protein solution and use the concentrated aqueous acidic solution or dry the solution and use the recovered dry protein.

10. Spray dry the aqueous acidic protein solution obtained by method 9 to form a dry protein mixture substantially free of membrane lipids that can be used in the present invention.

11. Lyophilize or evaporate the aqueous acidic protein solution obtained by method 9 to form the dry acidic protein mixture substantially free of membrane lipids that can be used in the present invention.

12. Increase the pH of the aqueous acidic protein solution from method 9 to about pH 5.0-5.5 to effect precipitation of the proteins and then readjust the protein back to a pH of about 4.0 or less using acid in a minimum volume to concentrate the aqueous acidic solution to between 1.6-15% protein.

13. Increase the pH of comminuted animal muscle tissue to a pH above about 10.5 to form the aqueous alkaline protein solution. In one embodiment, reduce the pH of the aqueous alkaline protein solution to below about 4.0 to form an aqueous acidic protein solution that can be used in the present invention. In a second embodiment, reduce the pH of the aqueous alkaline solution to about 5.0-5.5 to precipitate the protein, lower the pH of the precipitated protein to a pH of 4.0 or less to form a concentrated aqueous acidic solution and use the concentrated aqueous acidic protein solution or dry the solution and use the recovered dry protein mixture.

14. Spray dry the aqueous acidic protein solution obtained by method 13 to form a dry protein mixture that can be used in the present invention.

15. Lyophilize or evaporate the aqueous acidic protein solution obtained by method 13 to form the dry protein mixture that can be used in the present invention.

The protein products utilized in the present invention comprise primarily myofibrillar proteins that also contains significant amounts of sarcoplasmic proteins. The sarcoplasmic proteins in the protein product admixed with, injected into and/or coated on the uncooked food comprises above about 8%, preferably above about 10%, more preferably above about 15% and most preferably above about 18%, up to about 30% by weight sarcoplasmic proteins, based on the total weight of protein in the dry protein mixture, dry alkaline protein mixture, the aqueous alkaline protein solution and/or aqueous acidic protein solution.

The starting protein is derived from meat or fish, including shellfish muscle tissue. Representative suitable fish include deboned flounder, sole haddock, cod, sea bass, salmon, tuna, trout or the like. Representative suitable shellfish include shelled shrimp, crayfish, lobster, scallops, oysters or shrimp in the shell or like. Representative suitable meats include beef, lamb, pork, venison, veal, buffalo or the like; poultry such as chicken, mechanically deboned poultry meat, turkey, duck, a game bird or goose or the like.

In accordance with one embodiment of this invention, the dry protein mixture, dry alkaline protein mixture, aqueous alkaline protein solution or aqueous acidic protein solution of myofibrillar proteins and sarcoplasmic protein is mixed with one or more enzymes, which convert the protein to peptides thereby to produce a peptide composition which is added to food prior to cooking the food in order to retain moisture cooked food. The enzymes can be exoproteases and can be active to produce peptides at an acidic pH, an alkaline pH or a neutral pH. Representative suitable enzymes useful at acidic pH include Enzeco Fungal Acid Protease (Enzyme Development Corp., New York, N.Y.; Newlase A (Amano, Troy, Va.); and Milezyme 3.5 (Miles Laboratories, Elkhart, Ind.) or mixtures thereof. Representative suitable enzymes useful at alkaline pH include Alcalase 2.4 LFG (Novozyes, Denmark). Representative suitable enzymes useful at neutral pH include Neutrase 0.8 L (Novozymes, Denmark) and papain (Penta, Livingston, N.J.) or mixtures thereof. After, the peptides have been formed, their pH can be adjusted, either alone or in admixture with the protein composition of this invention to pH below about 4.0 or between about 10.5 and about 12.0 prior to applying them to an uncooked food to be cooked.

The enzymes utilized in amounts of between about 0.02% and about 2% preferably between about 0.05% and about 0.5% by weight based on the total weight of enzyme and protein at temperatures between about 4° C. and about 55° C., preferably between about 25° C. and about 40° C., for a time between about 5 mins. and about 24 hrs., preferably between about 0.5 hrs. and about 2 hrs. The enzyme can be inactivated by changing pH of the protein composition with which it is mixed. The peptides formed by reaction of the protein composition with the enzyme composition then can be recovered by drying the solution wherein the reaction takes place. Drying can be effected by evaporation, spray drying, freeze-drying or the like. The peptides produced are instantaneously soluble in water at neutral pH. The peptide composition can be added to uncooked food for the purposes set forth above.

The peptide products useful in this invention contain less than about 1 weight percent fats and oils (total), preferably less than about 0.2% weight percent fats and oils based on the weight of peptide. In addition, the peptide products utilized in the present invention contain less than about 2 weight percent ash, preferably less than about 0.2% weight percent fats and oils based on the weight of peptide. This low ash content is achieved by washing with water the protein starting material. Ash is defined as minerals, such as sodium, potassium, calcium, iron or phosphorous. In addition, the peptide products of this invention are instantly soluble in water to form a clear solution. Furthermore, the peptide products of this invention generally have lighter color whiteness units than the color whiteness units of a similar unhydrolyzed protein isolate from which they are derived as measured by a colorimeter with L, a, b capabilities. This lighter color is found with the hydrolyzed peptides of this invention derived from meats such as beef, pork or chicken as well as from dark muscle tissue from fish such as pelagic fish. This lighter color characteristic is desirable since it more easily permits dissolving the peptide product in water to form clear aqueous solutions.

Color whiteness index is determined by converting the L, a, b values utilizing the formula: 100 [(100−L)²+a²+b²]^{0.5}. Color is measured using a tristimulus colorimeter utilizing the universally adopted “L, a, b” opponent-type scale developed by Richard Hunter as is well known in the art. “L” is a measure of light ranging from white to black. The “a” value measures the range from green to red, and the “b” value measures the range from blue to yellow. With these three coordinates, a three-dimensional value can be assigned to any color.

In accordance with this invention the aqueous acidic protein solution, aqueous alkaline protein solution, the dry alkaline protein mixture or the dry protein mixture of myofibrillar proteins and sarcoplasmic proteins, and/or the peptide composition derived therefrom is applied to a surface of uncooked food to be cooked, or is injected into and/or is mixed with the uncooked food to be cooked. In a preferred embodiment of this invention, the uncooked food is both injected with and coated with the protein and/or peptide composition set forth above. The dry protein mixture, dry alkaline protein mixture, aqueous alkaline protein solution or aqueous acidic protein solution can be utilized alone or in admixture with a peptide composition derived therefrom. Alternatively, the peptide composition can be added alone to the uncooked food.

The term “a surface” as used herein is a surface of uncooked food which is positioned 90 degrees from an adjacent surface or surfaces of the uncooked food. In addition, the term “a surface” can comprise the connecting surface connecting two adjacent surfaces positioned 90 degrees from each other. Preferably, the entire surface of the uncooked food is coated with the dry acidic protein mixture, dry alkaline protein mixture, aqueous alkaline protein solution or aqueous acidic protein solution. The uncooked food containing the protein and/or the peptide then can be cooked at elevated temperature in acrylamide by the food being cooked.

In one aspect of this invention, particulate food such as ground meat or fish, e.g. hamburger, or a food mixture such as a pastry for doughnuts is mixed with the dry protein mixture, dry alkaline protein mixture, aqueous alkaline protein solution or aqueous acidic protein solution comprising myofibrillar proteins and sarcoplasmic proteins and/or the peptide composition derived therefrom at a weight ratio usually comprising about 0.03 to about 18% weight of the protein mixture based on the weight of the uncooked food, preferably between about 0.5 and 10% weight based on the weight of uncooked food and most preferably comprising between about 0.5 to about 7% weight based on the weight of the uncooked food. In addition, the aqueous acidic protein solution, aqueous alkaline protein solution or peptide solution derived therefrom can be added to the food in the same ratios based on the weight of and/or peptide precooked food. When the dry protein mixture, dry alkaline protein mixture, aqueous alkaline protein mixture or aqueous acidic protein solution and/or peptide composition derived therefrom is applied to at least one surface of the food, the amount of the protein and/or peptide mixture added is the same weight ratio as set forth above when mixed with uncooked food. When utilizing less than about 0.03% weight protein and/or peptide mixture or aqueous acidic protein and/or peptide solution, prevention of oil and/or fat absorption is not observed. When utilizing greater than about 15% weight protein and/or peptide, the uncooked food can become undesirably hard.

The uncooked food which is modified in accordance with this invention comprises vegetables, such as potato, corn, carrot or onion, tempura; nuts, mushrooms, flour based foods such as batter compositions, pastry compositions or the like. Additional foods include mushroom, nuts, batter compositions such as those comprising flour, egg and milk which can include additional food such as cornmeal, cracker meal or dusting meals.

The food containing the dry protein mixture, dry alkaline protein mixture, aqueous alkaline protein solution or aqueous acidic protein solution and/or the peptide composition then can be cooked above about 140° C. in a conventional manner such as by deep fat frying, pan frying, baking or the like. It has been found that the cooked food provided in accordance with this invention contains between about 25% and about 95%, preferably between about 50% and about 95% less acrylamide by weight as compared to the same cooked food free of the protein and/or peptide composition of this invention.

The following examples illustrate the present invention and are not intended to limit the same.

### EXAMPLE 1

### Extracted Chicken Proteins to Reduce Acrylamide Formation in Deep Fat Fried Potato

A chicken protein solution was manufactured according to U.S. Pat. No. 6,451,975 and concentrated using ultrafiltration and a 500,000 NWCO membrane filter (Koch Membrane, Wilmington, Mass.). Raw Russet potatoes suitable for french fries were obtained and cut into ⅜ inch strips and placed into cold water prior to frying.

Frozen chicken breast pieces were ground (Stephan Micro-cut, Columbus, Ohio) and then acidified in phosphoric acid, pH 3.0 to form the chicken protein solution, 1.7 wt. % solution of dissolved solids. After ultrafiltration, a 3% Brix solution corresponding to an approximately 2.5 wt/% protein solution was recovered.

Three sets of french fries were tested in accordance with this example. Sample 1 was a raw potato control which was not contacted with the protein solution. Sample 2 was a frozen raw potato control which was not contacted with the protein solution. Sample 3 was dipped into the chicken protein (3% Brix) and shaken to rid of excess protein (total approximately 5% pick-up), prior to being placed into a deep-fat fryer to fully cook for approximately 5 min, 30 seconds. Examples 1 and 2 were deep fat fried without any added protein. Product was analyzed for acrylamide content and the results are set forth in Table 1.

As can be seen from the data in Table 1, the french fried potato made in accordance with this invention contain less than about 30% by weight acrylamide.

TABLE 1

| | Acrylamide (ppb) |
|---|---|
| Sample #1 | |
| Raw Control FF | 344 |
| Sample #2 | |
| Frozen Control FF | 466 |
| Sample #3 | |
| Frozen Protein Dipped FF | 104 |

1. The process for reducing acrylamide formation in uncooked food containing asparagine and at least one reducing sugar during cooking of the food with a fat and/or oil which comprises:
(a) adding to said uncooked food a protein composition and/or a peptide composition selected from the group consisting of a dry protein mixture of myofibrillar proteins and sarcoplasmic proteins derived from animal muscle tissue, an aqueous acidic protein solution of myofibrillar proteins and sarcoplasmic proteins derived from animal muscle tissue and a peptide composition derived from myofibrillar proteins and sarcoplasmic proteins that are derived from animal muscle tissue and mixtures thereof by an adding method selected from the group consisting of applying said protein and/or peptide composition to at least one surface of said uncooked food, mixing said protein and/or peptide composition with said uncooked food, injecting said protein and/or peptide composition mixture into said uncooked food and a combination of said adding methods
and (b) cooking said uncooked food and protein and/or a peptide composition from step (a) at a temperature above about 140° C.

2. The process for reducing acrylamide formation in uncooked food containing asparagine and at least one reducing sugar during cooking of the food with a fat and/or oil which comprises:
(a) adding to said uncooked food a protein composition and/or a peptide composition selected from the group consisting of a dry alkaline protein mixture of myofibrillar proteins and sarcoplasmic proteins derived from animal muscle tissue, an aqueous alkaline protein solution of myofibrillar proteins and sarcoplasmic proteins derived from animal muscle tissue and a peptide composition derived from myofibrillar proteins and sarcoplasmic proteins that are derived from animal muscle tissue and mixtures thereof by an adding method selected from the group consisting of applying said protein and/or peptide composition to at least one surface of said uncooked food, mixing said protein and/or peptide composition with said uncooked food, injecting said protein mixture and/or peptide composition into said uncooked food and a combination of said adding methods
and (b) cooking said uncooked food and protein and/or a peptide composition from step (a) at a temperature above about 140° C.

3. The process of claim 1 wherein the protein and/or a peptide composition of myofibrillar proteins and sarcoplasmic proteins is applied to at least one surface of said uncooked food.

4. The process of claim 1 wherein the protein composition and/or peptide composition of myofibrillar proteins and sarcoplasmic proteins is applied to all surfaces of said uncooked food.

5. The process of claim 1 wherein the protein composition and/or peptide composition of myofibrillar proteins and sarcoplasmic proteins is mixed with said uncooked food.

6. The process of claim 1 wherein the protein composition and/or peptide composition is injected into said uncooked food.

7. The process of claim 1 wherein the protein composition and/or peptide composition is injected into said uncooked food and is applied to all surfaces of said uncooked food.

8. The process of claim 1 wherein said protein composition and/or said peptide composition is mixed with said uncooked food and is applied to all surfaces of said uncooked food.

9. The process of claim 1 wherein said protein composition and/or peptide composition is a dry protein and/or a peptide composition of myofibrillar proteins and sarcoplasmic proteins derived from animal muscle tissue.

10. The process of claim 1 wherein said protein and/or a peptide composition is an aqueous acidic protein and/or a peptide composition solution of myofibrillar proteins and sarcoplasmic proteins derived from animal muscle tissue.

11. The process of any one of claims 1, 2, 3, 4, 5, 6, 7 or 8 wherein said uncooked food is a vegetable.

12. The process of any one of claims 1, 2, 3, 4, 5, 6, 7 or 8 wherein said uncooked food is battered.

13. The process of any one of claims 1, 2, 3, 4, 5, 6, 7 or 8 wherein said uncooked food is battered and breaded.

14. The process of claim 11 wherein said vegetable is potato.

15. The process of any one of claims 1, 2, 3, 4, 5, 6, 7 or 8 wherein said uncooked food is flour based food.

16. The process of claim 11 wherein said vegetable is onion.

17. The process of any one of claims 1, 2, 3, 4, 5, 6, 7 or 8 wherein said protein composition and/or a peptide composition is derived from fish muscle tissue.

18. The process of any one of claims 1, 2, 3, 4, 5, 6, 7 or 8 wherein said protein and/or peptide composition is derived from poultry muscle tissue.

19. The process of any one of claims 1, 2, 3, 4, 5, 6, 7 or 8 wherein said protein composition and/or peptide composition is derived from meat muscle tissue.

20. The process of any one of claims 1, 2, 3, 4, 5, 6, 7 or 8 wherein said protein composition and/or a peptide composition is substantially free of animal membrane lipids.

21. The process of any one of claims 1, 3, 4, 5, 6, 7, 8, 9 or 10 wherein the pH of said dry protein mixture, said aqueous acidic protein solution and said peptide composition is between about 2.5 and about 3.5.
